(19) United States
(12) Patent Application Publication
(10) Pub. No.: US 2010/0013918 A1
(43) Pub. Date: Jan. 21, 2010

(54) VIEWING SYSTEM

(75) Inventor: Olingar Ta ' Eed, Abergavenny (GB)

Correspondence Address: Intellectual Property Dept.;Dewitt Ross & Stevens SC, 2 East Mifflin Street, Suite 600, Madison, WI, 53703-2865, US

(73) Assignee: PEDAGOG LIMITED, Hengoed (GB)

(21) Appl. No.: 11/718,354

(22) PCT Filed: Oct. 28, 2005
(86) PCT No.: PCT/GB2005/004168

§ 371 Date: Oct. 1, 2009

(30) Foreign Application Priority Data
Nov. 3, 2004 (GB) 0424337.4

(51) Int. Cl. H04N 5/222; H04N 7/18

(52) U.S. Cl. 348/143; 348/333.01; 348/E07.085; 348/E05.022

(57) ABSTRACT

A surveillance system comprising a middleware server (10) connected via a SMPP link to an SMSC (12). The surveillance system enables two-way connection to a plurality of image capture devices, such as video cameras or webcams (14). Image data captured by the cameras (14) is transmitted via GPRS and a private data communication network (16) to the middleware server (10). Data included with the image data indicative of the IP addresses of the respective image capture devices (14) from which the captured images originate is identified and the mobile communication devices, e.g. mobile telephones, registered as authorised to receive the captured images, or data relating thereto, are determined. Automatically, or upon request, the streamed image data received in the middleware server (10) from the image capture devices (14) is transmitted to the respective authorised client (18).

This invention relates generally to a viewing system and, more specifically, to a wireless viewing system and method of providing same.

There are many circumstances in which a user in a first location may wish to see images captured in respect of a second location, remote from the first location, for example, for surveillance, monitoring or entertainment purposes. For example, a user may wish to receive images and/or monitor activity occurring at their home or business premises whilst they are elsewhere.

It is therefore an object of the present invention to provide a system which enables a user to receive images on a local communications device, such as a personal computer, PDA or mobile telephone, captured by an image-capture device at a remote location.

In accordance with a first aspect of the present invention, there is provided a viewing system, comprising means for storing address data representative of a plurality of remote image capture devices and corresponding address data representative of one or more remote communications devices authorised to receive images captured each of said remote image capture devices, means for receiving image data captured by one of said image capture devices across a data communications network, means for identifying address data representative of said image capture device and identifying the corresponding address data of one or more remote communications devices authorised to receive images therefrom, and means for transmitting said image data to an authorised remote communications device across a data communications network.

Also in accordance with the first aspect of the present invention, there is provided a method of providing a viewing system, comprising storing address data representative of a plurality of remote image capture devices and corresponding address data representative of one or more remote communications devices authorised to receive images captured each of said remote image capture devices, providing means for receiving image data captured by one of said image capture devices across a data communications network, providing means for identifying address data representative of said image capture device and providing lookup means for identifying the corresponding address data of one or more remote communications devices authorised to receive image data therefrom, and providing transmission means for transmitting said image data to an authorised remote communications device across a data communications network.

In a preferred embodiment, the surveillance system comprises a server having a client interface for enabling communication thereof with said remote communications devices and a camera interface for enabling communication thereof with said remote image capture devices. The image data is preferably transmitted from said remote image capture devices to said surveillance system via a private data communications network, having a unique access point name (APN). Beneficially, said image data is transmitted by said viewing system to one or more authorised remote communications devices via a public data communications network.

The viewing system beneficially comprises an image database for receiving and storing image data received from said remote image capture devices. In a preferred embodiment, a user database is provided for storing said address data representative of a plurality of remote image capture devices and corresponding address data representative of one or more remote communications devices authorised to receive images captured each of said remote image capture devices. In one exemplary embodiment, means may be provided for receiving a signal from a remote image capture device indicating that activity has been identified in a respective field of view therein, and in response to receipt of such a signal, said viewing system may be arranged and configured to transmit a request signal to said remote image capture device to commence transmission of image data captured in respect of said field of view in which activity has been identified from said remote image capture device to said viewing system. In another exemplary embodiment, the surveillance system may be arranged and configured to monitor image data received from said remote image capture devices and identify activity occurring therein. In either case, means are preferably provided for transmitting a signal to a remote communications device indicating that activity has been identified in the field of view of a remote image capture device in respect of which said remote communications device is authorised to receive image data.

In accordance with a second aspect of the present invention, there is provided an image capture device for use with a viewing system as defined above, the image capture device comprising means for capturing image data in respect of a field of view thereof, means for compressing said image data, means for identifying activity within said field of view, means for establishing a connection across a data communications network with said viewing system and transmitting data via said connection to said viewing system indicative that activity has been identified within said field of view and means for causing image data captured in respect of said field of view to be stored in response to activity being identified therein.

In a preferred embodiment, the means for identifying activity in said field of view may comprise a motion sensor provided in or on said image capture device. The motion sensor may, for example, comprise a passive infra-red (PIR) sensor or the like. Image processing means may additionally or alternatively be provided for identifying activity within image data captured by the image capture device. A communications module, such as a GPRS module, and antenna are beneficially provided in or on said image capture device for establishing said connection across said data communications network and transmitting data across said data communications network.

Storage means, such as RAM memory or similar volatile memory means, may be provided in or on said image capture device for storing said image data captured in respect of said field of view in which activity has been identified. Additionally or alternatively, the image capture device is arranged and configured to transmit image data captured in respect of said field of view in which activity has been identified across said data communications network to said viewing system for storage. In this regard, the image capture device may comprise means for receiving a signal from said viewing system to commence transmission of image data thereto.

These and other aspects of the present invention will be apparent from, and elucidated with reference to, the embodiments described herein.

Embodiments of the present invention will now be described by way of examples only and with reference to the accompanying drawings, in which:

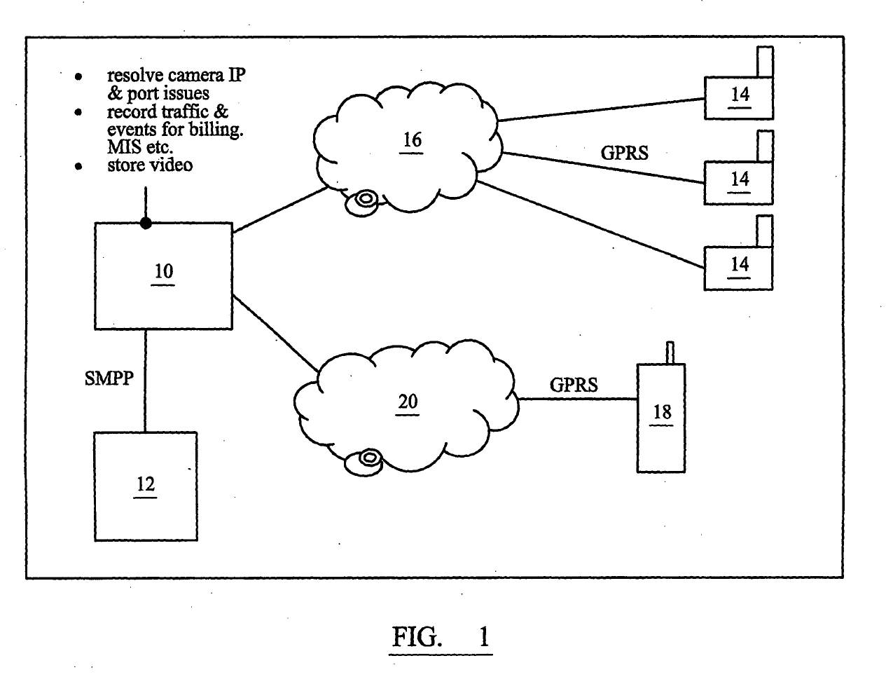

FIG. 1 is a schematic block diagram illustrating the principal components of a surveillance system according to an exemplary embodiment of the present invention;

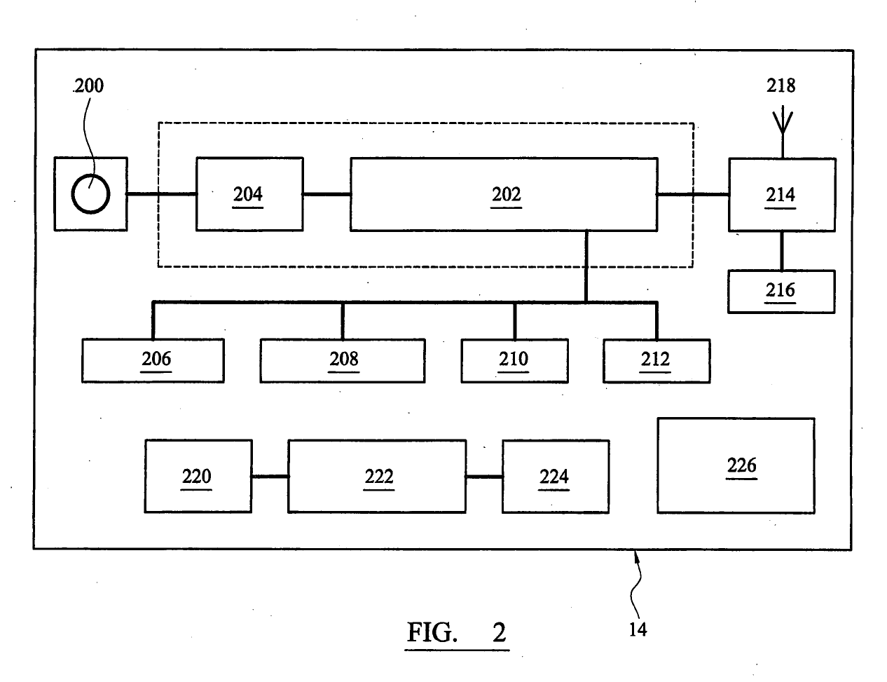

FIG. 2 is a schematic block diagram illustrating the principal components of an image capture device according to an exemplary embodiment of the present invention; and

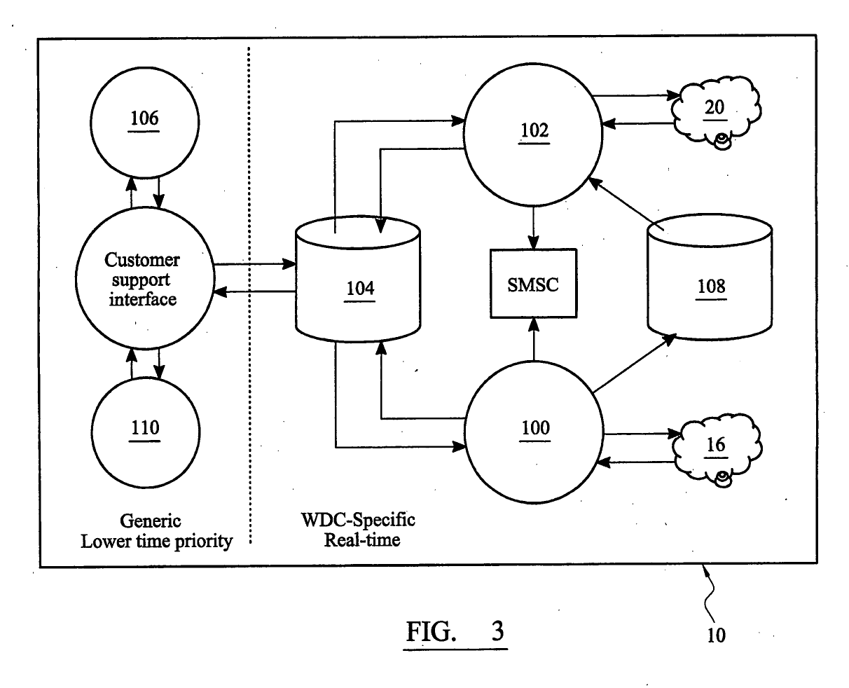

FIG. 3 is a schematic block diagram of the principal components of the server middleware of the system of FIG. 1.

Referring to FIG. 1 of the drawings, a surveillance system according to an exemplary embodiment of the present invention comprises a middleware server 10 connected via a SMPP link to an SMSC 12. SMSC is an abbreviation for the words Short Message Service Centre. An SMSC provides a number of services, in particular the regulation of the transfer of text messages between mobile telephones. When a user sends a text message (or SMS message) to a recipient, the telephone actually sends the message to an SMSC which stores the message and then delivers it to the destination recipient when they are available. Additionally, the message centre will generally take care of any charging that needs to take place. Generally speaking, there is at least one SMSC per network. For bulk transmission and reception of SMS messages, SMSC's have conventional, fixed network interfaces as well as mobile network interfaces. A number of protocols have been defined to support this sort of wire-line access, and SMPP is the most commonly used of these protocols.

The Short Message Peer to Peer (SMPP) protocol is an open industry standard messaging protocol designed to simplify integration of data applications with wireless mobile networks such as GSM, TDMA, CDMA and PDC. This protocol is widely deployed in the telecommunications industry, as will be known to a person skilled in the art, and will not be discussed in any further detail herein.

Referring back to FIG. 1 of the drawings, the surveillance system enables two-way connection to a plurality of image capture devices, such as video cameras or webcams 14. This connection is preferably via a private data communications network 16 (such as a wireless local area network) having a unique Access Point Name (APN) which can be used by the image capture devices 14 to establish a connection to the middleware server 10, and vice versa.

A highly suitable communication service for communication between the image capture devices 14 and the data communications network 16 is GPRS. General Packet radio Service (GPRS) is a non-voice service that allows information to be sent and received across a data communications network 16. Theoretical minimum speeds of up to 171.2 kilobits per second (kbps) are achievable with GPRS using all eight timeslots at the same time. This is about three times as fast as the data transmission speeds possible over today's fixed telecommunications networks and ten times as fast as current Circuit Switched Data services on GSM (Global System for Mobile Communications) networks. GPRS has the advantage of facilitating instant connections whereby information can be sent or received immediately as the need arises, subject to radio coverage. No dial-up modem is necessary. However, it will be appreciated that the present invention is not intended to be limited to GPRS, other digital networks may be equally applicable, including (but not limited to) 3G TETRA, CDMA, PCS, etc.

Several image capture devices could be networked via, for example, Bluetooth® which is an industrial specification for wireless personal area networks (PANs) and provides a way to connect and exchange information between devices such as digital cameras via a secure, low-cost globally available short range radio frequency. Bluetooth® allows such devices to “talk” to each other when they come into range, even if they are not in the same room, as long as they are within 10 metres (32 feet) of each other. The Bluetooth® protocol operates in the license-free ISM band at 2.45 GHz and reaches speeds of 723.1 kbps.

Referring back to FIG. 1 once again, image data captured by the cameras 14 is transmitted via GPRS and a private data communications network 16 to the middleware server 10. Data included with the image data indicative of the IP addresses of the respective image capture devices 14 from which the captured images originate is identified, and the mobile communications devices, e.g. mobile telephones, registered as authorised to receive the captured images, or data relating thereto, are determined. Automatically, or upon request, the streamed image data received in the middleware server 10 from the image capture devices 14, and preferably stored therein, is transmitted to the respective authorised (client) mobile telephones 18, preferably by GPRS via a public data communications network 20, e.g. the Internet, again having a unique Access Point Name (APN) which can be used by the middleware server 10 to establish a connection to the mobile telephones 18, and vice versa.

The above-described server architecture is desirable because of the way current mobile telecommunications networks are implemented. In general, GPRS network operators use a combination of Dynamic Host Configuration Protocol (DHCP) together with Network Address Translation (NAT) and/or Port Address Translation (PAT) to allow mobile equipment to be dynamically assigned a private-range IP address for the duration of a data session. The absence of bi-directional address resolution at their servers, together with restrictions on their billing mechanisms, results in direct transfer of data from one node (e.g. mobile telephone) to another being effectively prevented. Thus, in the current environment, in order to allow data to be transferred from an image capture device 14 to a mobile telephone 18, it is necessary for both nodes to establish a connection to a server 10 which is ‘visible’ to them both on a public, static IP address.

It is for this reason, among others that, in the illustrated configuration it is envisaged, that the image capture devices 14 will be equipped with SIMs from a network provider, and that a private APN will be set up with that provider to allow the image capture devices access to the internet and, thereby, to the server 10. However, this is not essential, and will tend to be dependent upon the evolution of the manner of operation of network providers into the future.

On the other hand, the client devices 18 (which may comprise mobile telephones, but are not restricted to this platform, and it will be appreciated that a client application 18 may be created for any internet-connected device capable of supporting basic user interface features and displaying the images, including but not limited to a personal computer (PC), a laptop computer, a PDA, a palmtop computer, etc.) can establish a connection from any network provider, as long as they can connect to the Internet and “see” the server 10, and as long as there is no firewall or port restrictions in place on the client's APN 16 which block the surveillance system's TCP/IP traffic.

A camera 14 suitable for use in the surveillance system described above is illustrated schematically in FIG. 2 of the drawings. Generally, the camera 14 consists of hardware and embedded software which together perform video capture, video compression, video motion detection, video storage and GPRS transmission to a server (10). The basic functional requirements of the camera 14 are, in this exemplary embodiment, to capture images from a colour CMOS camera module, compress captured images using JPEG compression, transfer compressed images over a GPRS connection to a remote server on request, motion detection, and local storage and upload of pre/post-event images.

Accordingly, the camera 14 illustrated in FIG. 2 of the drawings, comprises a camera module 200 and a processor 202 to which the camera module 200 is connected via a camera interface module 204. The processor 202, which includes software to effect image data compression, is connected to a passive infra-red motion sensor 206, status indicators 208, a flash memory module 210 and a RAM memory module 212. The processor 202 is also connected to a GPRS module 214 having a SIM 216 and an antenna 218. Also illustrated, but of less significance, are an external power supply unit 220, a power management module 222, a Lithium-ion battery 224 and ancillary support devices (denoted generally as 226). Of course, it will be appreciated that the power supply may comprise any suitable means, including solar, battery, mains, etc.

The camera module 200 may be a colour CMOS camera module having an 8-bit YUV 4:2:2 output format, I²C control interface and fixed focus lens. The camera interface 204 would then also be required to support I²C control and the JPEG compression means in the processor 202 should be capable of accepting 8-bit YUV 4:2:2 image data and performing JPEG compression with user-definable quantisation and huffmann tables. The processor 202, more generally, should ideally be capable of interfacing to all other system components with a minimum of additional components,

The flash memory 210 provides non-volatile storage of application software and configuration settings (preferably minimum 256 KB) and the RAM memory 212 provides volatile storage for application data and compressed images (again, preferably 256 KB).

The SIM 216 may be a 3V GPRS data-enabled SIM, and a SIM holder may be required (if this is not integrated in the GPRS module 214). Network specific APN login details can be stored in the flash memory 210. The SIM 216 will not be readily removable, and some degree of tamper-proofing will ideally be provided by the camera enclosure.

The antenna 218 may be internal or external and dual-band, tri-band or quad-band, depending on the choice of GPRS module 214. The passive infra-red (PIR) motion detector 206, beneficially has an opto-insulated input and current-limited PIR power output. It will be appreciated that, in addition to PIR motion detection, video motion detection is preferably also provided in respect of the captured imaged data, so as to minimise the occurrence of false alarms.

The status indicators 208 may comprise at least one LED to indicate power and operational status, a second LED to indicate whether motion detection is activated and a third LED may indicate whether a mobile network connection has been made. A lead in respect of the power supply unit 220 (e.g. input: 100-240V AC 50-60 Hz; output: 5V DC at min. 2.4 A) may emerge from a grommet from the camera body and terminate in a suitable DC connector.

The power management module 222 will generate all of the voltages required for operation of the various system components and smart battery charging may also be supported. The ancillary support devices 226 may include power-on reset circuitry, timing generators (crystals/clocks) and interface circuitry between the various components. It is envisaged that other functions, such as wireless hubs, PTZ (pan, tilt, zoom), temperature sensors, meter reading etc. may also be incorporated in, or otherwise supported by, the camera module 14, and the present invention is not intended to be limited in this regard.

Finally, the camera enclosure may comprise an injection moulded plastic enclosure incorporating a Fresnel lens for the PIR and incorporating the camera module 200 and lens. An external switch is beneficially provided to soft switch power on/off, so as to allow the camera to attach/detach the GPRS connection cleanly. A waterproof recessed reset switch may be provided which can be used to force a complete power down and reset the device completely, if required.

An overview of the main camera functions is as follows:
establish and maintain authenticated connection to server
send and receive keepalive messages
send images in response to server request
adapt transmission rate in response to server responses
set image quality hi/med/lo in response to server request
set motion detection sensitivity hi/med/lo/off in response to server request
set motion detection on/off in response to external switch
store images in short-term (˜10 second) circular buffer
apply motion detection algorithm—alert server on event

The main functions of a surveillance system, according to an exemplary embodiment of the invention will now be described in more detail. When the unit is turned on, the camera firmware establishes a connection to the middleware server via the chosen private APN authentication settings are hard-coded in the firmware. The firmware uses the unique hardware ID from the GPRS module to identify itself to the server. The server verifies that the ID belongs to a valid account. This relationship will have been established when the device is first registered by the purchaser. The camera and server then intermittently exchange short keep-alive messages to ensure that the connection between them is maintained as ‘always on’. If the camera does not receive a message from the server within the timeout period, the firmware automatically forces a reconnection attempt.

In response to the client activity the server may send a message to the camera requesting that it begin to capture and send images. The user can set the camera to three levels of image quality, and the camera will capture and send images at the current quality setting. Image request messages from the server inform the camera about the most recent throughput rate, and the camera adapts its rate of transmission to match the available bandwidth. This avoids a build up of latency during the session. Forward error correction is built in to the communications protocol, to avoid corrupted data being passed on to the client device.

An external switch enables or disables video motion detection (VMD). The user can also enable/disable and set three levels of sensitivity for VMD via the client application. When VMD monitoring is enabled, in response to activation of the sensor, the camera may send an alert message to the server, and optionally may also capture and send images to the server for a pre-determined period. The camera is configured to store ˜10 seconds worth of images in a circular buffer when VMD monitoring is enabled, and can therefore automatically send a sequence of ‘before and after’ images to the server for later review by the client.

The server (10) consists of software components (the middleware) hosted on a Windows server with a static public IP address. The software components communicate with both camera and client devices. The server is responsible for the authentication of cameras and clients, and for receiving images from cameras, and delivering them to clients. Additional server components record data throughout on a per camera and per client basis for billing purposes.

An overview of the main server functions is as follows:
accept camera connections
accept client connections
authenticate cameras and clients against database of registration details
exchange keepalive messages with cameras
send list of available cameras to client on connection
start/stop image streaming from camera
route images through to client
route image quality and VMD mode/sensitivity commands to camera
send SMS in response to camera alert
log connections and data throughput
handle billing records
send reverse-billed SMS
provide MIS information

Referring to FIG. 3 of the drawings, the server middleware components have access to a database (104) of registered users which contains authentication details for clients, cameras, and the relationships between them.

One client may be permitted access to multiple cameras. One camera may be accessible to multiple clients. Some cameras will be ‘public’ accessible to anyone. The middleware server components access this database in read-write mode and real-time, so as to establish the validity of connection requests from cameras and clients. Current status flags in the records for cameras and clients are also updated in response to communications between the middleware and remote devices.

The same database is accessed in read-write mode, but with lower time priority by other, more generic components which support service provision functions e.g. the registration and activation of a newly-purchased camera. These modules require standard CRM type functionality, and will do little that is specific to the system architecture. The server will expose a web interface (106) to allow customer to change certain features of their accounts themselves, as well as a more powerful admin interface (110) which will only be accessible to e.g. call centre operators or administrators.

The middleware server consists of two types of interface thread, one (100) for cameras and one (102) for clients. The threads are independent and multi-instance, allowing for a high degree of scalability, but both types of thread require read-write access to the user database (104). Each interface module is responsible for handling the authentication of camera or client, and for all the communication taking place between the remote device and the server. Direct communication between threads is not required, image data is written to and read from an image database (108) which supports multi-threaded read-write access.

The interface components log their activity, and the volume of data transferred is recorded for each transaction. This data is used to support the billing function and manage the costs of the operation, as well as providing management information.

In response to a request, images are sent from the camera to the server, and then on to the client in blocks or units equivalent to 15 second's worth of video. Each time a unit of video is successfully sent to the user, the server increments the billing record. For PAYT clients, the middleware is responsible for sending a reverse-billed premium rate SMS ‘receipt’ to the connected client when video images are successfully sent. For contract clients, the billing is managed differently, but still based on the volume of data transferred.

In response to an alert message from a camera (e.g. following video motion detection activation) the server can send an SMS message, via an SMPP link, to one or more registered client phones selected by the user.

The client consists of a software application which can be installed and run on a Java enabled colour mobile phone (18). The application can establish an authenticated connection to the server (10), and then receive and display the images sent to it by the server. The functions of the client can similarly be implemented on a laptop or palmtop computer, PDA or Windows PC platform, for example.

An overview of the main client functions is as follows:
establish and maintain authenticated connection to server
PIN protect access to application
allow user to select desired camera
allow user to set image quality
allow user to enable/disable VMD monitoring and set sensitivity
display images received from camera
display current camera settings

Running the client application software in a surveillance system according to an exemplary embodiment of the invention, requires the entry of a PIN number, which is selected by the user at the time the software is registered. Once running, the client application establishes a connection to the middleware server via the internet APN of the user's chosen network provider. The client sends authentication information which includes the PIN used to activate the software, and a unique identifier for the phone. These Ids will have been notified to the service provider at the time of software registration. This method prevents a stolen phone or pirated client application being used to obtain unauthorised access to the camera.

Once authenticated, the client receives a list of camera devices which are registered to it, and which the server knows to be currently active. The user can select the camera from which they wish to receive images, and this selection is sent to the server. The server sends a message to activate the selected camera, along with a configuration block which specifies the required capture resolution. When images are received by the server they are routed through to the relevant client. Once the images are received, the client software displays them.

The client software also allows the user to configure options such as image quality, VMD on/off/sensitivity etc. The client can optionally display additional information such as duration of session and cost incurred.

The communications protocol proposed in respect of the system described above supports the following messages.

| Message | From | To |
|---|---|---|
| Camera logon request | Camera | Server |
| Camera logon confirmation | Server | Camera |
| Camera configuration read request | Server | Camera |
| Camera configuration read response | Camera | Server |
| Camera configuration write request | Server | Camera |
| Camera configuration write response | Camera | Server |
| Camera image start/stop/throughput request | Server | Camera |
| Camera image response | Camera | Server |
| Camera event notification | Camera | Server |
| Keepalive message | Server | Camera |
| Keepalive message | Camera | Server |
| Client logon request | Client | Server |
| Client logon confirmation | Server | Client |
| Client camera list request | Client | Server |
| Camera list response | Server | Client |
| Client camera live image request | Client | Server |
| Client camera stored image request | Client | Server |
| Client image response | Server | Client |
| Client camera configuration read request | Client | Server |
| Client camera configuration read response | Server | Client |
| Client camera configuration write request | Client | Server |
| Client camera configuration write response | Server | Client |

The image request and response messages include fields which provide information on data throughput, allowing the client firmware and server middleware to dynamically adapt their rates of transmission to the bandwidth available.

System security may be provided as follows (although the present invention is not intended to be limited this regard):

When a camera 14 initiates communication with the server 10, it sends a logon message containing the unique IMEI number of the GPRS module 214 and the unique IMSI number of the SIM card 216. This unique combination is checked by the middleware server 10 against records of registered users held in the server database 104. If the unique combination of IMEI and IMSI is not found in the database 104, or is found to be associated with an invalid device (e.g. stolen equipment), the session is immediately terminated. If the IMEI/IMSI combination belongs to a legitimate user, the session is initiated, and the camera status held in the database 104 is updated to “active”.

When a client application initiates communication with the server 10, it sends a logon message containing the unique serial number associated with the copy of the software on the client phone 14, and a four digit PIN number which must be entered by the user every time the application is launched. This unique combination is checked by the middleware server 10 against records of registered users held in the database 104. If a matching record is not found (e.g. incorrect PIN), or is found to be associated with an invalid client (e.g. customer has closed their account) then the session is immediately terminated. If the unique serial number/PIN combination is found to be associated with a valid client, then the session is initiated.

The client can request a list of cameras 14 to which he has access rights. The middleware server 10 checks the database 104 and builds a list of currently active cameras 14 to which the specified client has access rights, and this is sent to the client. The list of displayed to the user, who can then select their preferred camera, and opt to view either live images or recorded incidents from it.

Compressed images sent from the camera 14 to the server 10, either during a “live” monitoring session, or as the result of alarm activation, are time-stamped automatically as they arrive at the server 10. A 32 bit cyclic redundancy checksum is also calculated for each image, and the timestamp and CRC are stored as a metadata record in the image database 108 alongside each image. This provides a means of identifying alterations or modifications to the image from its original state.

Although the present invention has been described above, by way of example only, as a surveillance system, it will be appreciated that a viewing system according to the invention would be equally applicable for remote viewing of, for example, sporting or entertainment events, monitoring remote machinery telematic information, etc. and the present invention is not intended to be limited in this regard.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A viewing system, comprising means for storing address data representative of a plurality of remote image capture devices and corresponding address data representative of one or more remote communications devices authorised to receive images captured each of said remote image capture devices, means for receiving image data captured by one of said image capture devices across a data communications network, means for identifying address data representative of said image capture device and identifying the corresponding address data of one or more remote communications devices authorised to receive images therefrom, and means for transmitting said image data to an authorised remote communications device across a data communications network.

2. A system according to claim 1, comprising a server having a client interface for enabling communication thereof with said remote communications devices and a camera interface for enabling communication thereof with said remote image capture devices.

3. A system according to claim 1, wherein said image data is transmitted from said remote image capture devices to said surveillance system via a private data communications network, having a unique access point.

4. A system according to claim 1, wherein said image data is transmitted by said surveillance system to one or more authorised remote communications devices via a public data communications network.

5. A system according to claim 1, comprising an image database for receiving and storing image data received from said remote image capture devices.

6. A system according to claim 1, comprising a user database for storing said address data representative of a plurality of remote image capture devices and corresponding address data representative of one of more remote communications devices authorised to receive images captured each of said remote image capture devices.

7. A system according to claim 1, comprising means for receiving a signal from a remote image capture device indicating that activity has been identified in a respective field of view therein, wherein in response to receipt of such a signal, said surveillance system is arranged and configured to transmit a request signal to said remote image capture device to commence transmission of image data captured in respect of said field of view in which activity has been identified from said remote image capture device to said surveillance system.

8. A system according to claim 1, arranged and configured to monitor image data received from said remote image capture devices and identify activity occurring therein.

9. A system according to claim 1, comprising means for transmitting a signal to a remote communications device indicating that activity has been identified in the field of view of a remote image capture device in respect of which said remote communications device is authorised to receive image data.

10. A surveillance system according to claim 1.

11. A method of providing a viewing system, comprising storing address data representative of a plurality of remote image capture devices and corresponding address data representative of one or more remote communications devices authorised to receive images captured each of said remote image capture devices, providing means for receiving image data captured by one of said image capture devices across a data communications network, providing means for identifying address data representative of said image capture device and providing lookup means for identifying the corresponding address data of one or more remote communications devices authorised to receive image data therefrom, and providing transmission means for transmitting said image data to an authorised remote communications device across a data communications network.

12. An image capture device for use with a viewing system according to claim 1, the image capture device comprising means for capturing image data in respect of a field of view thereof, means for compressing said image data, means for identifying activity within said field of view, means for establishing a connection across a data communications network with said viewing system and transmitting data via said connection to said viewing system indicative that activity has been identified within said field of view and means for causing image data captured in respect of said field of view to be stored in response to activity being identified therein.

13. An image capture device according to claim 12, wherein said means for identifying activity in said field of view comprises a motion sensor provided in or on said image capture device.

14. An image capture device according to claim 12, comprising image processing means for identifying activity within image data captured by the image capture device.

15. An image capture device according to claim 12, comprising a communications module and antenna provided in or on said image capture device for establishing said connection across said data communications network and transmitting data across said data communications network.

16. An image capture device according to claim 12, comprising memory means provided in or on said image capture device for storing said image data captured in respect of said field of view in which activity has been identified.

17. An image capture device according to claim 12, arranged and configured to transmit image data captured in respect of said field of view in which activity has been identified across said data communications network to said viewing system for storage.

18. An image capture device according to claim 17, comprising means for receiving a signal from said viewing system to commence transmission of image data thereto.
